(19) United States
(12) Patent Application Publication
(10) Pub. No.: US 2026/0110858 A1
(43) Pub. Date: Apr. 23, 2026

(54) COMBINED MULTIPLE SHELL LENS FACET WITH TOTAL INTERNAL MULTI-LIGHT-PATH TUNNELLING

(71) Applicant: Samba Photonics Lab Inc., Irvine, CA (US)

(72) Inventors: Xiaolin Tong, Irvine, CA (US); Xiaotian Steve Yao, Las Vegas, NV (US); Danshu Rao, Beijing (CN)

(21) Appl. No.: 18/919,765

(22) Filed: Oct. 18, 2024

(51) Int. Cl. G02B 6/42

(52) U.S. Cl. CPC G02B 6/4214; G02B 6/4206; G02B 6/4216; G02B 6/423

(57) ABSTRACT

A silicon-photonics co-packaged optical connector (CPO) is disclosed. The connector provides combined multiple shell lens facet with total internal multi-light-path tunneling. Total optical reflection at the multiple lenses ensures minimal loss, preserved polarization mode dispersion (PMD) and controlled numerical aperture (NA). The shell lens design is inspired by the chirality of seashell symmetry when placed in reference to a symmetry axis and the ensuing special flexibility. An exemplary manufacturing process of the CPO with shell lens is also disclosed.

### FIELD OF INVENTION

The present application relates to optical coupling systems designed for use in photonic applications, including but not limited to laser or photodiodes and optical fiber coupling, as well as coupling between silicon photonics (SiPho) components and optical fibers. The application addresses the need for efficient, flexible, and low-loss light management and coupling, with applications particularly suited for transceiver manufacturers, SiPho fabrication, silicon photonics packaging, and server/switcher system manufacturers.

### BACKGROUND OF THE INVENTION

In modern optical systems, efficient coupling between laser or photodiode components and optical fibers, as well as silicon photonics components and optical fibers, is critical. Current coupling methods often result in significant optical loss, complex integration, and limitations on flexibility in coupling ratios and numerical apertures (NA). The present application provides a coupling system with a flexible path ratio, controllable numerical aperture, minimal optical interfaces, superior index matching, and an adaptable geometric size.

### BRIEF SUMMARY OF THE INVENTION

According to one example of the application, a coupling system with flexible path ratio is provided. The coupling system manages light through internal reflection, enabling coupling with any path ratio. This flexibility allows for optimized light direction and improved efficiency across varied path ratios, providing versatility for diverse optical configurations.

According to another example of the application, the coupling system provides controllable numerical aperture (NA). The coupling system includes an internal reflection surface that allows for on-demand adjustment of the numerical aperture. By managing the NA through internal reflection, the coupling system ensures that light is focused and aligned efficiently, adapting to the requirements of different optical components or applications.

According to yet another example of the present application, the coupling system has minimal optical interfaces. The coupling system minimizes optical loss by reducing the number of surface boundaries that light encounters, such as reducing the number of glass-to-air surfaces to the minimum, even to its physical limit. Light travels through an “in, reflection, out” pathway, significantly reducing optical loss associated with unnecessary interfaces, thereby enhancing transmission efficiency.

According to another example of the present application, the coupling system provides superior index matching. The system incorporates superior index matching capabilities, with the index matching properties being modifiable as required for specific applications. This feature reduces reflection loss at interfaces and ensures optimal light transmission. Additionally, the lens size within the system can be modified according to the chip to lens fixture, to the fiber array mechanical dimension requirement, enabling customization based on specific NA requirements to ensure compatibility with various fiber arrays and optical configurations.

According to another example of the present application, the coupling system provides adjustable geometric size. The geometric size of the optical lens can be varied to meet the specific needs of the numerical aperture, ensuring an ideal fit for fiber arrays and achieving efficient light coupling between components.

In the examples of the present application, the coupling system is designed for integration with transceiver modules and silicon photonics packaging. The system is compatible with laser/photodiode arrays and can be employed in server and switcher systems requiring precise, flexible optical coupling. The system is fabricated to allow easy scalability and adjustment, making it ideal for SiPho component integration in compact and high-performance photonics applications.

The present application may be applied across a range of photonics and optical industries, including Transceiver Manufacturing; Silicon Photonics Fabrication (SiPho Fabrication); Silicon Photonics Packaging Manufacturing; Server/Switcher System Manufacturing. This advanced optical coupling system offers a superior solution for the manufacturers in these industries, providing an ideal balance of efficiency, adaptability, and reduced optical loss in silicon photonics and optical fiber coupling applications.

A connector facilitates signal transmission between a silicon chip and optical fibers is disclosed. The connector includes a silicon chip with multiple waveguides and a cable with corresponding optical fibers, aligned by an alignment structure such as a Fiber Array Unit (FAU). A lens assembly with first and second reflective surfaces reshapes the optical beam profile for optimal coupling efficiency. The first reflective surface receives an expanding optical beam from either the waveguides or fibers, parallelizes it, and reflects it to the second reflective surface, which focuses the beam and transmits it to the opposite interface. The reflective surfaces also adjust the beam profile, converting between oval and circular shapes as needed. This connector design enhances the precision and efficiency of optical signal coupling in integrated photonic applications.

A method enables efficient signal transmission between a silicon chip and optical fibers is also disclosed. It involves providing a silicon chip with multiple waveguides and a cable with corresponding optical fibers, aligned by an alignment structure such as a Fiber Array Unit (FAU). The method uses a lens assembly with first and second reflective surfaces to reshape the profile of an optical beam transmitted between the waveguides and fibers, ensuring optimal coupling. The first reflective surface receives an expanding optical beam from either the waveguides or fibers, parallelizes it, and reflects it to the second reflective surface, which focuses and transmits the beam to the opposite interface. The reflective surfaces adjust the beam profile, converting between oval and circular shapes as necessary. This method enhances precision and efficiency in optical signal coupling, making it ideal for integrated photonic applications.

The system facilitates signal transmission between a silicon chip and optical fibers, featuring a silicon chip with multiple waveguides and a cable containing corresponding optical fibers is disclosed. An alignment structure, such as a Fiber Array Unit (FAU), ensures accurate alignment between the fibers and waveguides. A lens assembly, comprising a first and second reflective surface, reshapes the optical beam profile to enable efficient coupling. The first reflective surface receives an expanding optical beam from the waveguides, parallelizes it, and reflects it to the second reflective surface, which focuses and directs the beam to the optical fibers. In reverse operation, the second reflective surface can receive the beam from the fibers, parallelize it, and direct it to the waveguides. The reflective surfaces can also alter the beam profile, converting between oval and circular shapes as needed. This design optimizes signal coupling for integrated photonic applications.

### BRIEF DESCRIPTION OF THE DRAWINGS

FIG. 1 is a diagram of a CPO connector with shell lens assembly according to an example of the present application;

FIG. 2 is a diagram illustrating in greater detail the CPO interconnection using the shell lens assembly;

FIG. 3. is a cross-sectional view of the CPO interconnection using design shell lens assembly;

FIG. 4 illustrates the dual shell lens concept with two seashells or shells;

FIG. 5 illustrates and exemplary optical beam shape transition from waveguide to the I/O fiber using the shell lens of the present application;

FIG. 6 illustrates a detached view and an assembled view of the shell lens as it assembled with PIC and FAU according to an example of the present application; and

FIG. 7 illustrates an exemplary reflow process employed to assemble and secure the FAU with an integrated shell lens onto the PIC.

### DETAILED DESCRIPTION OF THE INVENTION

The following detailed description of the present application refers to the accompanying drawings, which form a part hereof and show, by way of illustration, specific embodiments in which the present application may be practiced. These embodiments are described in sufficient detail to enable those skilled in the art to practice the present application, and it is to be understood that other embodiments may be utilized and that structural changes may be made without departing from the scope of the present application.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

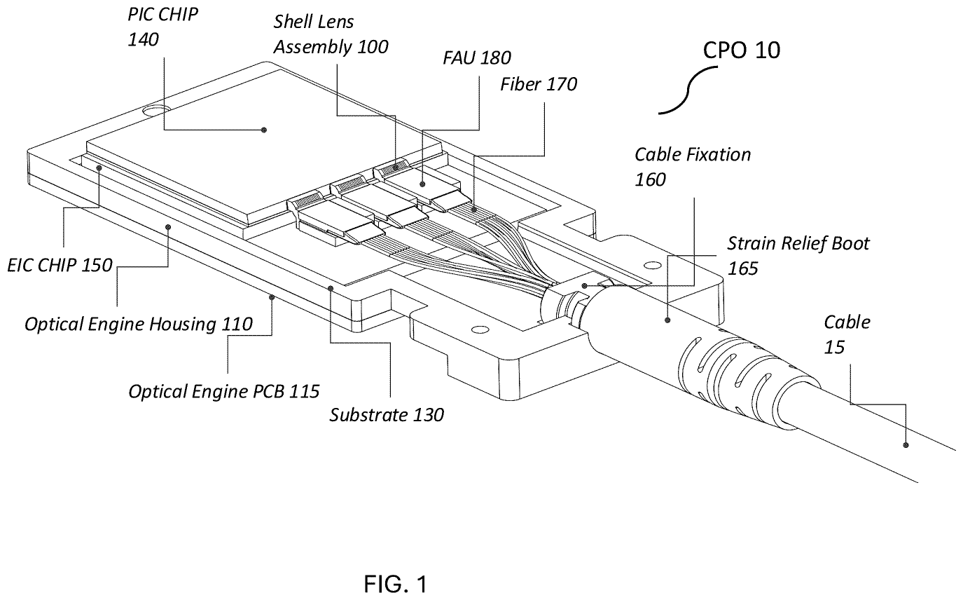

FIG. 1 is a diagram of a co-packaged optical connector (CPO or CPO connector) with shell lens assembly according to an example of the present application. Referring to FIG. 1, the CPO connector 10 includes multiple ports wherein through fiber array units (FAUs) 180, optical fiber 170 may be plugged in to SiPho units, i.e. the Photo Integrated Chip (PIC or PIC Chip) 140 of the CPO 10.

The FAU 180 serves as an intermediate connecting and alignment point for optical fibers 170 to be optically connected to the PIC 140. As illustrated in FIG. 1, each FAU 180 gather multiple optical fibers 170 carried over to the CPO by cable 15. Cable 15 is protected by a strain relief boot 165 as it running into the CPO 10. Cable 15 is fixed onto the optical engine housing 110 with a cable fixation 160. According to one example, the optical engine housing 110 is located on the optical engine printed circuit board (PCB) 115, which provides a foundation to the optical engine housing 110.

According to the present application, the CPO 10 is an exemplary optical engine. Therefore, the optical engine housing 110 is the housing for CPO 10 in the example, albeit the different terms used herein. In FIG. 1, the optical engine housing 110 only covers the bottom part of the CPO 10. According to the present application, a top part of the housing (not shown) is also provided to match the bottom part of the housing, therefore forming a complete housing encasing all parts of the optical engine as illustrated in FIG. 1. The optical engine housing 110 is provided for structural support for the components of the CPO connector 10. The optical engine housing 110 helps to maintain the precise alignment of all the components within the CPO connector 10.

According to one example of the present application, the shell lens assembly (or shell lens) 100 located at the front of the FAU 180 is configured to facilitates efficient coupling of optical signals transmitted between the PIC 140 and optical fibers 170, ensuring minimal signal loss.

The shell lens assembly 100 is one of the optical components that manages the direction, focus, and NA of the optical beams transmitted between the PIC chip 140 and optical fibers 170. According to exemplary embodiments of the present application, the lenses, or reflective surfaces, in the shell lens assembly 100 may have various curvatures, such as spherical, elliptical, or asymmetric etc., based on specific requirements, enabling control over optical beam convergence, divergence, and polarization of the optical beam transmitted there in as needed.

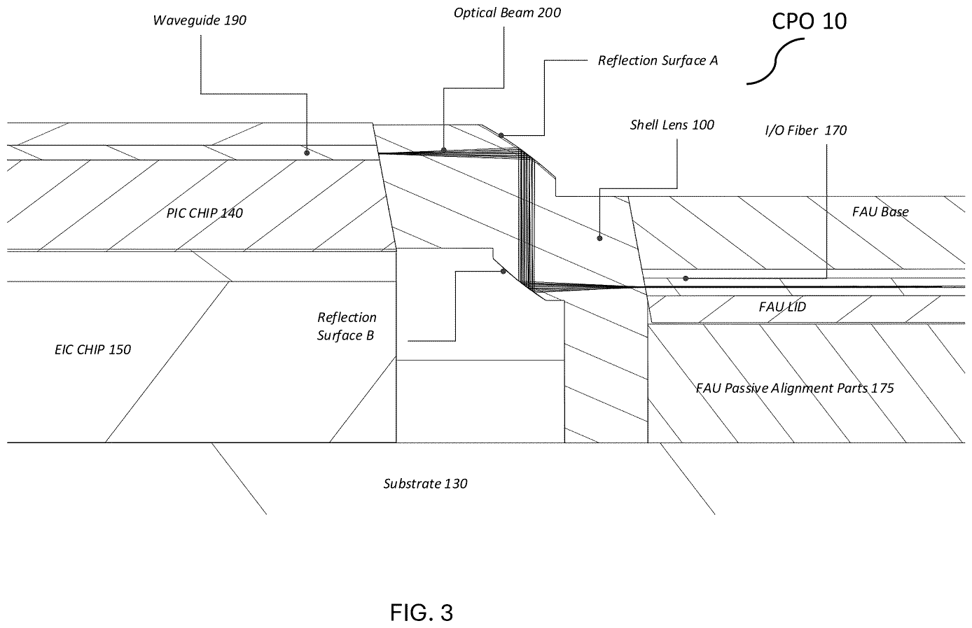

The shell lenses in the shell lens assembly 100 have special-designed curvature to (1) internally reflect the light beam without loss or polarization mode dispersion (PMD), and (2) focus the light beam to control the numerical aperture (NA). Although the examples hereinafter disclose dual shell lens pars, the scope and spirit of the application is not so limited. In fact, multiple shell lens facets with total internal path may be designed or used. The one-stage “zigzag” line of the optical path (or tunnelling), as shown in the illustrated examples of the present application (See, e.g., FIG. 3) can be extended to many stages. According to one example, total reflection occurs at each of the multiple shell lens, thereby preserving the advantages of the dual shell lens examples with regard to signal loss, no PMD and controlled NA.

According to an example of the present application, two reflective surfaces, may be aligned to control the optical pathway and modify the beam shape. Such a configuration for the shell lens assembly 100 will be described in greater details below.

According to one example of the present application, substrate 130 provides the foundational layer for the manufacturing process of the PIC chip 140, the EIC chip 150 and/or other silicon components thereon. As illustrated in FIG. 1, post-manufacturing substrate 130 may provide foundational support for the PIC chip 140 and EIC chip 150 thereupon, aligning them with the shell lens assembly 100 for optimal signal transmission. It ensures that both the optical and electronic signals are precisely integrated therein.

The PIC chip 140 emits or receives optical signals, interacting with the shell lens assembly 100 to facilitate efficient coupling into or out of the fiber 170. The lens-controlled numerical aperture (NA) helps to align the light emitted from the PIC chip 140 with minimal deviation, maximizing transmission efficiency.

According to an example of the present application, the PIC chip 140 is positioned between the PIC chip 140 on the top, and the substrate 130 the bottom. The EIC chip 150 processes electronic signals that may correspond to the optical signals transmitted through the optical fibers 170. The close positioning has the advantages of allowing integrated optical-electronic signal management within the assembly.

Further referring to FIG. 1, the FAU 180 aligns the fiber 170 with the shell lens assembly 100 and is responsible for securely holding the fiber in place, ensuring precise signal coupling. It includes passive alignment parts 175 (not shown) that stabilize the fiber 170 without the need for active adjustments.

The optical fibers 170 serve as the input and output (I/O) medium, coupled to the shell lens assembly 100 via the FAU 180. Light directed through the shell lens assembly 100 exits into the optical fibers 170, ensuring high transmission quality with minimal loss due to carefully managed beam shape and NA control.

The CPO 10 operates by focusing light from the PIC chip 140 through the shell lens assembly 100 to the fiber 170 while maintaining the controlled NA and optical beam shape. Light emitted from the PIC chip 140 is directed by Surface A and reflected onto Surface B, which focuses it precisely into the fiber 170. The FAU 180 and passive alignment parts 175 maintain stable positioning, allowing for consistent, high-quality signal transmission across the fiber interface. The optical engine housing 110 and substrate 130 provide structural support, while the controlled geometry of the shell lens 100 accommodates various coupling needs by modifying NA and beam shape to optimize light transfer.

According to an example of the application, the CPO 10 may be utilized as a high-performance CPO switch. In one example (not shown), the CPO 10 is interconnected to multiple FAUs, where the FAUs are packaged within a cable assembly to facilitate connection with various types of terminal ports. Such terminals may include front panel ports, Input/Output (I/O) connection interfaces, and Physical Layer System (PLS) blind mate connectors, such as Multi-fiber Push-On (MPO) connectors, which are adaptable to pluggable laser sources.

According to an example of the application (not shown), each FAU contains a structured array of optical fibers, designed for high-density fiber alignment, which are aligned with and coupled to the CPO 10 to enable efficient optical data transmission. The integrated optical and electrical components of CPO 10, such as the PIC chip 140 and EIC chip 150, facilitating the conversion and routing of signals with minimal loss and latency, which is essential for high-speed applications, such as those in demand in datacenters.

In an exemplary embodiment (not shown), each FAU is connected to the CPO via a precision fiber alignment mechanism that ensures optimal coupling efficiency between the FAU's fiber optics and the CPO's photonic interfaces. The FAUs are secured in place within a structured cable assembly designed to support and protect the optical fibers and maintain precise alignment during use. This cable assembly enables flexible interconnectivity while maintaining the high-speed performance required by the CPO switch.

The cable assembly is further configured to terminate at various types of connector interfaces. At the front panel, the cable assembly can terminate in standard I/O connections, facilitating quick and easy access for system upgrades, replacements, or reconfigurations. Additionally, the cable assembly may be terminated with PLS blind mate connectors, such as MPO connectors. These MPO connectors are specifically designed for seamless integration with pluggable laser sources, allowing for straightforward interconnections without manual alignment requirements.

In another example (not shown), the MPO connectors are integrated into a modular port structure, enabling blind mate connections between the CPO and external laser sources. This modularity facilitates the integration of high-power laser sources, which are critical in meeting the high-speed and high-bandwidth demands of next-generation data centers and networking equipment. When connected, the MPO connectors provide reliable and secure mating, thereby preserving signal integrity and reducing optical losses throughout the transmission path.

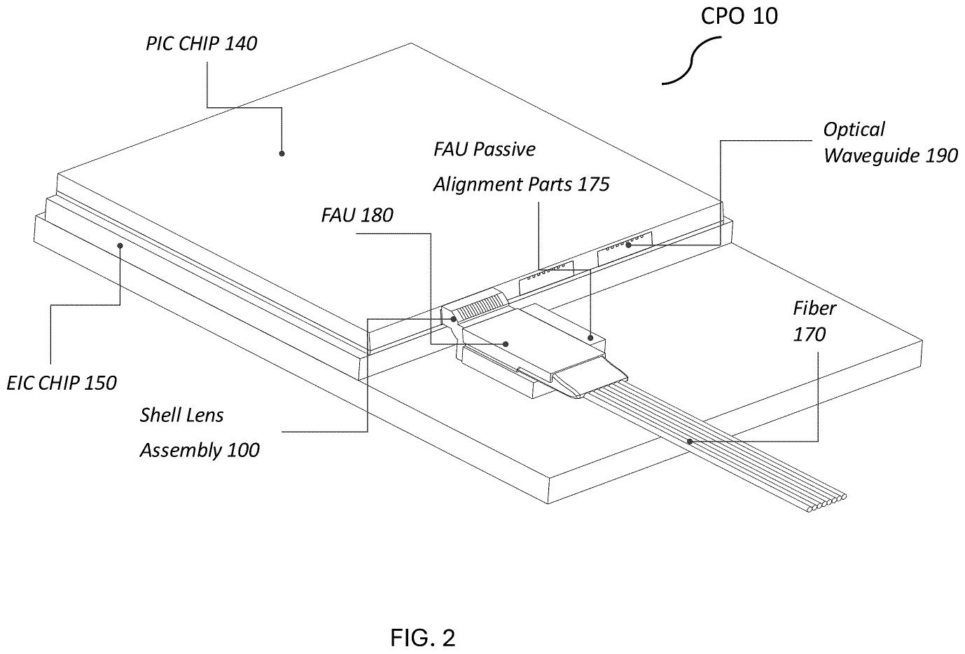

FIG. 2 is a diagram illustrating in greater detail the CPO 10 interconnection using the shell lens assembly. Referring to FIG. 2, the shell lens assembly 100 that links the PIC chip 140 to the FAU 180 is illustrated. Referring to FIG. 2, the PIC chip 140 is positioned at the central photonic element, housing the optical waveguide 190. The optical waveguide 190 enables the propagation and direction of optical signals within the chip. The optical waveguide 190 is designed to align with the shell lens 100, ensuring efficient transmission of optical signals. The optical waveguide 190 directs light from the PIC chip 140 toward the shell lens, acting as the primary pathway for optical communication.

As illustrated in FIG. 2, the shell lens assembly 100 is positioned between the optical waveguide 190 of the PIC chip 140 and the FAU 180. It is the essential intermediary optical component, focusing and collimating light from the PIC chip 140's waveguide 190 before it reaches the FAU 180. The shell lens assembly 100 facilitate precise alignment with the optical waveguide, optimizing signal coupling and minimizing loss. The shell lens assembly 100 will be described in greater detail below in FIGS. 3-7.

As described above, the FAU 180 contains multiple optical fibers 170 that align with the shell lens assembly 100. The FAU 180's passive alignment parts enable the proper positioning of the fiber array relative to the shell lens assembly 100. This passive alignment structure simplifies assembly, ensuring that the fibers are positioned accurately without the need for active adjustment mechanisms.

The optical fibers 170 within the FAU 180 are aligned to capture and transmit the focused light from the shell lens assembly 100 to other components or systems, such as external optical networks, as described in greater detail elsewhere. The shell lens assembly 100 and FAU 180 alignment maximizes light transfer efficiency from the PIC chip 140 to the fiber array.

As will be appreciated by skilled artisan, the overall design emphasizes precise interconnection, with the shell lens assembly 100 playing a crucial role in focusing and aligning optical signals from the PIC chip 140's waveguide 190 to the FAU 180, enhancing signal integrity and reducing optical loss. This assembly supports high-performance optical communication through effective integration of photonic components.

FIG. 3. is a cross-sectional view of the CPO interconnection using design shell lens assembly. Referring to the FIG. 3, the optical path of the optical beam as it traverses between the FAU 180 and the PIC chip 140 is illustrated therein. The optical beam reflects off two reflective surfaces, Surface A and Surface B. These reflective surfaces play a critical role in managing the beam's optical characteristics, including size and focus, as it progresses towards the waveguide.

For an optical beam 200 transmitting via optical fiber 170 to the PIC chip 140, the optical path begins at the I/O optical fiber 170 in the FAU 180. The optical beam 200 is launched toward Surface B transmitting in the horizontal direction as illustrated in FIG. 3. According to one example, the optical beam 200 transmits in air after exiting the fiber 170. Upon exiting the optical fiber 170 to air, the optical beam 200 undergoes natural divergence, causing it to expand as it propagates until it reaches Surface B. Surface B is configured in such a way that as it reflects the optical beam 200 perpendicularly for 90 degrees upward, it also adjusts the direction of the component optical paths within the beam 200 to make all optical paths become parallelling. In other words, the optical beams 200 stops further expanding between Surface B and Surface A.

Skilled artisans understand that this can be done by selecting Surface B's curvature or angle that is typically designed to control this expansion rate, ensuring that the optical beam 200 remains well-directed and aligned with subsequent optical components. This controlled reflection by Surface B optimizes the optical beam 200's trajectory and prepares it for efficient coupling into the next stage of the optical path.

At Surface A, the optical beam 200 takes another 90-degree turn to again transmit horizontally. Surface A is configured to reverse the initial beam expansion from the fiber 170 to Surface B, focusing and refining the optical beam as it approaches the PIC chip 140's waveguide 190. The curvature and positioning of Surface A are finely calibrated to converge the expanded beam precisely at the waveguide 190's entrance on the PIC chip 140, achieving a high degree of coupling efficiency. This focused convergence is essential for minimizing insertion losses, ensuring the optical beam 200's energy is effectively transferred into the waveguide 190 for optimal optical transmission within the PIC chip 140.

According to the present application, Surface A and Surface B are examples of a dual shell-lens configuration. The dual-shell configuration as used in the present application indicates an inversion symmetry, that when two lenses of the same chirality are paired facing each other, a chirality-maintained-but-opposite inversion symmetry is formed. The “dual shell” concept of the present application is a shorthand for such an inversion symmetry that is akin to two seashells placed opposite each other, each of the see shell is a non-symmetrical chiral structure.

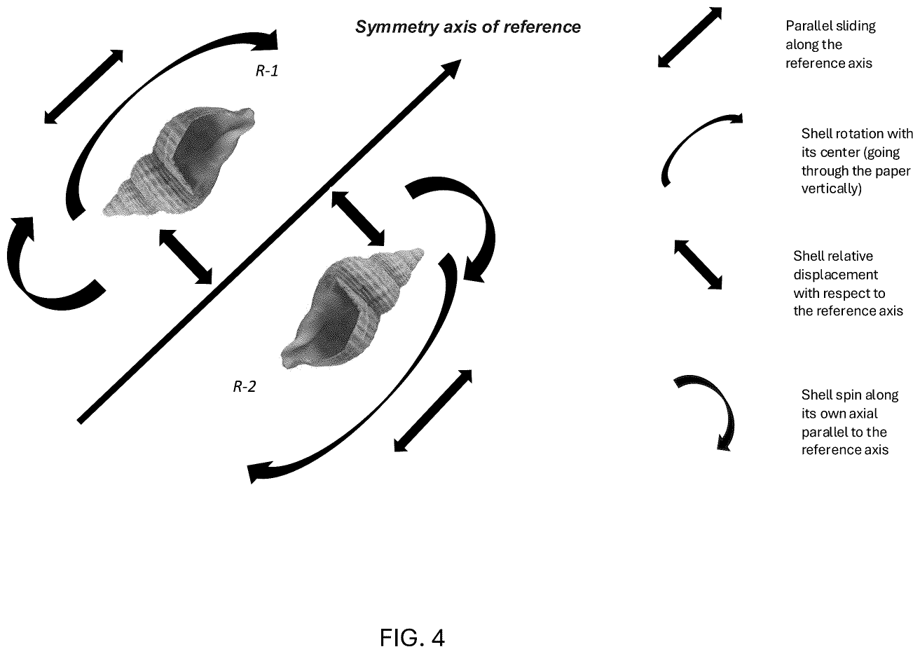

FIG. 4 illustrates the shell lens concept using two seashells or shells as analogy. The dual shells represent two identical reflective surfaces, namely R-1 and R-2, that guide optical beams between optical fiber and a silicon waveguide with high efficiency and spatial flexibility. The two reflective surfaces are structured analogously to shells, with each shell possessing distinct reflective properties and orientations that facilitate optimal light transmission through internal reflection.

As illustrated in FIG. 4, each reflective surface, R-1 and R-2, is capable of adjusting its position relative to a central symmetry axis, thereby allowing for substantial spatial freedom. In various configurations, illustrated by directional arrows, the reflective surfaces can translate along the symmetry axis, enabling alignment across multiple orientations to meet specific optical path requirements. This spatial freedom supports versatile light transmission paths, with the reflective surfaces positioned dynamically to manage the direction and angle of incident beams with precision. According to one example of the present application, the R-1 and R-2 always move or rotate in the inversion symmetrically.

The flexible configurations permit the optical beams to be redirected at various angles between the fiber and the waveguide, enabling diverse optical orientations. By utilizing this spatial freedom, the reflective surfaces maintain alignment even when the system undergoes axial adjustments. Such freedom ensures that the optical coupling remains consistent regardless of minor adjustments to the position of the reflective shells.

The dual reflective surfaces are designed to exhibit symmetrical movement about a central reference axis. This symmetry provides a uniform optical path regardless of directional variations, ensuring consistency in beam orientation from input to output. When both reflective surfaces rotate symmetrically about the reference axis, they maintain the optical path's alignment, allowing for efficient light transfer across the entire coupling system.

The symmetrical turn is particularly advantageous for applications requiring multiple orientations of beam alignment. For instance, in a configuration where R-1 and R-2 are symmetrically rotated relative to the reference axis, the reflective surfaces adapt their orientation to sustain optimal light coupling. This adaptability between the fiber and the waveguide, achieved through synchronized symmetry, allows the system to feed optical beams into different orientations based on operational requirements, providing a robust solution for multi-directional optical coupling needs.

According to another example, each shell may rotate around its center axis, which runs parallel to the reference axis, enabling precise angular adjustments that adapt to specific optical setups. This rotation, illustrated in the top view projection, accommodates slight variances in optical path requirements by modifying the incidence and reflection angles of the beam. Additionally, each shell can slide parallel to the reference axis or spin along its own axis, affording it fine-tuned control over beam trajectory and orientation.

By leveraging the combination of shell rotation, sliding, and relative displacement along the reference axis, the system enables a wide range of beam orientations and configurations. This flexibility is ideal for applications that demand both high precision and adaptability in optical alignment, as it maintains the beam's integrity across various coupling setups and ensures minimal optical loss due to misalignment or interface discontinuity.

Persons skilled in the art understand the FIG. 4 is provided to assist the explanation of the idea of shell lens assembly.

Referring back to FIG. 3, skilled artisan understands that optical beam 200 transmitted from the PIC chip 140's waveguide 190 to the I/O optical fiber 170 will undergo the same beam expansion and focusing, albeit the optical path starts from the waveguide 190, reflected by Surface A then Surface B, and reaches the I/O optical fiber 170.

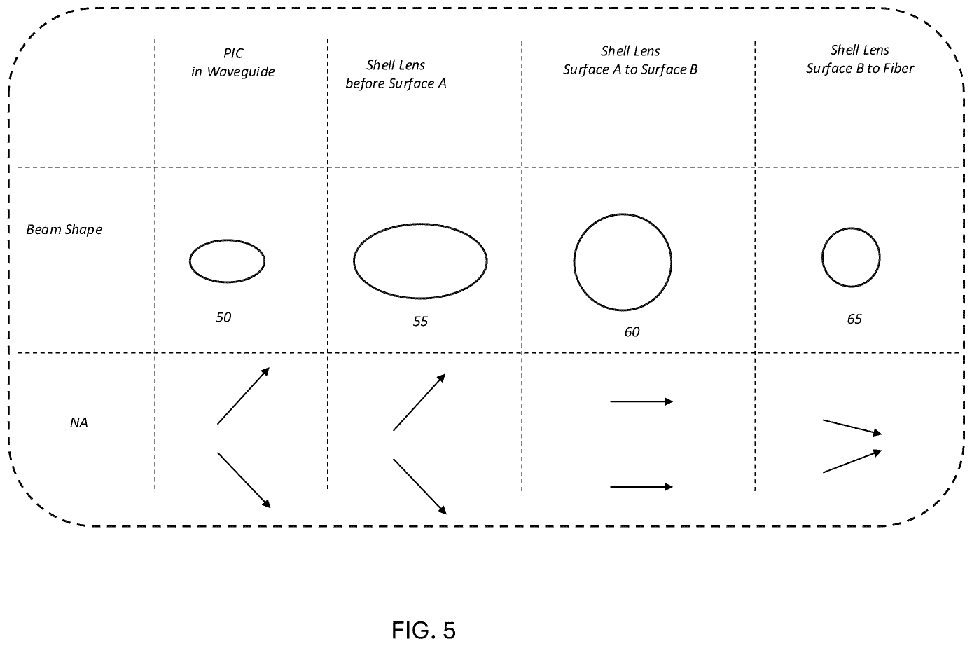

FIG. 5 illustrates and exemplary optical beam 200 shape transition from waveguide 190 to the I/O fiber 170 using the shell lens of the present application. Referring to FIG. 5, the optical beam 200 exits the waveguide 190 in an initial oval shape 50. The waveguide 170 emits the beam 200 with an elongated profile, typically resulting from the waveguide's design to maximize signal intensity within its confines. This initial oval shape to allows the beam 200 to interface with subsequent components, beginning the shape transition process.

After exiting the waveguide 190, the beam 200 travels toward Reflective Surface A. Reflective Surface A is configured to intercept the oval-shaped beam 200, which has expanded slightly to oval shape 55, due to natural beam divergence upon reaching Reflective Surface A. Reflective Surface A modifies the shape of the beam 200, transforming it from an enlarged oval 55 to a circular profile 60, thereby optimizing the beam's cross-sectional symmetry for improved coupling efficiency. The circular shape 60 created by Reflective Surface Ais then maintained as the beam 200 continues to propagate.

The circular beam 200, now uniform in shape, travels to Reflective Surface B. Reflective Surface B is positioned at an angle to receive the beam in its circular form. The distance between Reflective Surfaces A and B is set to ensure the beam 200 retains its circular shape and size during transit. Reflective Surface B is specifically engineered to refocus the circular beam, modifying its size without altering its shape as shown in 65.

Upon reaching Reflective Surface B, the circular beam 200 is focused to a reduced diameter, making it suitable for coupling into the fiber 170. Reflective Surface B acts as a focusing mechanism, adjusting the beam's diameter to match the fiber's core size. This final transformation results in a smaller circular beam profile that aligns with the fiber 170 for optimal coupling and minimal loss.

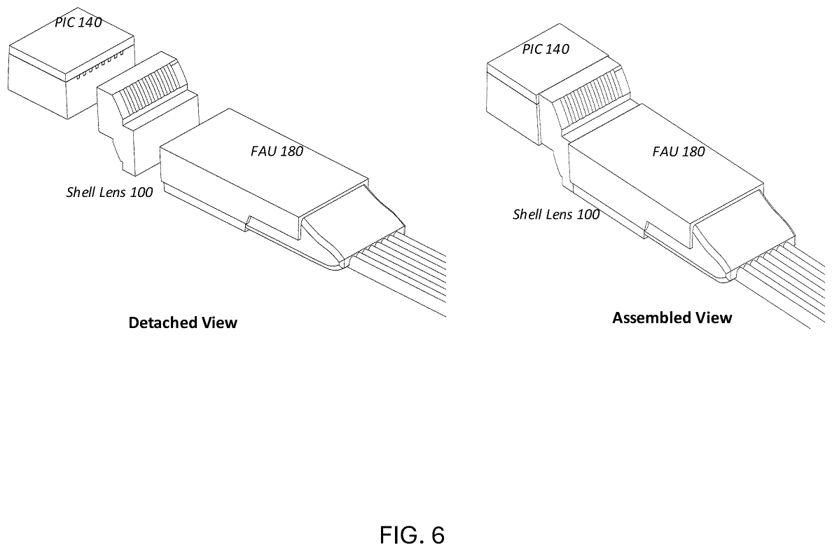

FIG. 6 illustrates a detached view and an assembled view of the shell lens as it assembled with PIC and FAU according to an example of the present application. Referring to the detached view of FIG. 6, the PIC 140, shell lens assembly 100, and FAU 180 are separated along a common optical axis, providing the spatial arrangement of each component in relation to the others. In the assembled view of FIG. 6, the PIC 140, shell lens assembly 100, and FAU 180 are depicted in their operational alignment along a linear path, with each component secured in close proximity to maintain an uninterrupted light path. The shell lens 100 assembly is held in direct alignment with both the PIC 140 and FAU 180, allowing for efficient transmission and reception of optical signals.

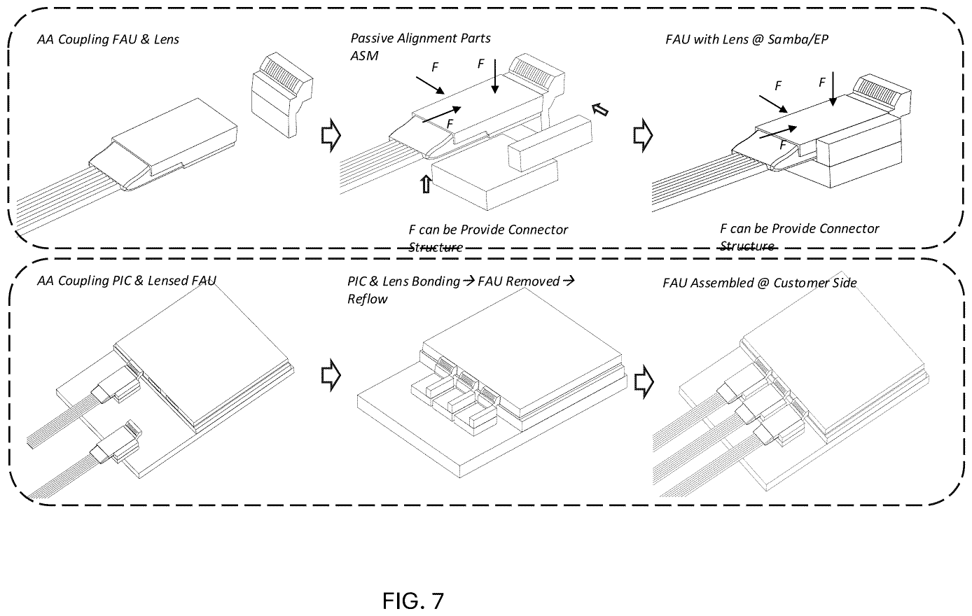

FIG. 7 illustrates an exemplary reflow process employed to assemble and secure the FAU with an integrated shell lens onto the PIC. The process allows for precision alignment and bonding of components in a manner that supports subsequent detachment and reattachment without compromising performance.

Referring to FIG. 7, the process begins by passively aligning, such as via an angular alignment (AA), of the FAU 180 and the shell lens assembly 100 with the PIC 140, utilizing coupling structures illustrated therein. These structures ensure that the FAU 180, the shell lens assembly 100, and PIC share a common optical axis, enabling accurate light transmission across the optical assembly. The lens alignment is achieved by placing the shell lens assembly 100 in an intermediary position, focusing and guiding light from the PIC 140 to the FAU 180.

As illustrated in FIG. 7, once aligned, bonding material, such as solder or a specialized adhesive, is applied to critical contact points between the PIC 140 and the lensed FAU 180 assembly. This bonding material is chosen to support the reflow process, providing a secure attachment while allowing for modular assembly and detachment. The bonding material initially remains solid to hold the components in place until reflow heating is applied.

In an exemplary reflow stage, controlled heat is applied to the assembly, causing the bonding material to reach its melting point, thereby reflowing and creating a robust, fused bond between the components. During this reflow process, the alignment structures maintain the positional accuracy of the FAU 180 and shell lens relative to the PIC 140, ensuring that the optical alignment remains intact.

Following the reflow process, the assembly is gradually cooled, solidifying the bonding material and securing the FAU 180, shell lens assembly 110, and PIC 140 in their precise alignment. The cooled bonding material now serves as a durable connection that maintains optical alignment during operation. The modular design, however, allows for detachment of the FAU 180 or lens 100 if needed for maintenance, replacement, or upgrades. This reflow bonding is compatible with customer-side assembly processes, where the FAU 180 may be reassembled at the final installation site, providing flexibility in production and logistics.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. The embodiments described are not intended to be exhaustive or to limit the present application to the precise forms disclosed. Rather, they are chosen and described to best explain the principles of the present application and its practical applications, thereby enabling others skilled in the art to utilize the present application in various embodiments and with various modifications as are suited to the particular use contemplated. This application is intended to cover any adaptations or variations of the specific embodiments discussed herein. Therefore, it is intended that this disclosure be limited only by the claims and the equivalents thereof, and not by the specific examples given. The scope of the present application is to be determined by the claims appended hereto, interpreted in accordance with established doctrines of claim interpretation.

What is claimed is:

1. A connector for interfacing signal transmission between silicon chip and with optical fibers, comprising:
a silicon chip comprising a plurality of waveguides;
a cable comprising a plurality of optical fibers;
at least one alignment structure positioned to align the optical fibers with the waveguides on the silicon chip; and
a lens assembly comprising:
a first reflective surface;
a second reflective surface;
wherein the first and the second reflective surface are configured to reshape a profile of an optical beam transmitted between the waveguides and the fibers via the first and second reflective surfaces for efficient coupling.

2. The connector of claim 1,
wherein the first reflective surface receives an expanding optical beam from the plurality of waveguides, parallelizes and reflects the optical beam to the second reflective surface; and
wherein the second reflective surface receives the paralleled optical beam, focuses and reflects the optical beam to the plurality of optical fibers.

3. The connector of claim 1,
wherein the second reflective surface receives an expanding optical beam from the plurality of optical fibers, parallelizes and reflects the optical beam to the first reflective surface; and
wherein the first reflective surface receives the paralleled optical beam, focuses and reflects the optical beam to the waveguides.

4. The connector of claim 2, wherein the profile of the optical beam received by the first reflective surface is an oval and changed to a circle after reflection.

5. The connector of claim 2, wherein the profile of the optical beam received by the second reflective surface is a circle and is changed to an oval after reflection.

6. The connector of claim 1, wherein the alignment structure is a fiber array unit (FAU).

7. The connector of claim 6, where the plurality of waveguides are located within a plurality of ports, each port corresponding to an FAU.

8. A method for interfacing signal transmission between a silicon chip and optical fibers, comprising:
providing a silicon chip comprising a plurality of waveguides;
providing a cable comprising a plurality of optical fibers;
positioning at least one alignment structure to align the optical fibers with the waveguides on the silicon chip; and
reshaping, using a lens assembly comprising a first reflective surface and a second reflective surface, a profile of an optical beam transmitted between the waveguides and the fibers, wherein the first and second reflective surfaces guide the optical beam for efficient coupling.

9. The method of claim 8, further comprising:
receiving an expanding optical beam from the plurality of waveguides at the first reflective surface;
parallelizing and reflecting the optical beam from the first reflective surface to the second reflective surface; and
focusing and reflecting the optical beam from the second reflective surface to the plurality of optical fibers.

10. The method of claim 8, further comprising:
receiving an expanding optical beam from the plurality of optical fibers at the second reflective surface;
parallelizing and reflecting the optical beam from the second reflective surface to the first reflective surface; and
focusing and reflecting the optical beam from the first reflective surface to the waveguides.

11. The method of claim 9, wherein the profile of the optical beam received by the first reflective surface is an oval and is changed to a circular profile after reflection.

12. The method of claim 9, wherein the profile of the optical beam received by the second reflective surface is a circle and is changed to an oval profile after reflection.

13. The method of claim 8, wherein the alignment structure is a fiber array unit (FAU).

14. The method of claim 13, wherein the plurality of waveguides are located within a plurality of ports, each port corresponding to an FAU.

15. A system for interfacing signal transmission between a silicon chip and optical fibers, comprising:
a silicon chip comprising a plurality of waveguides;
a cable comprising a plurality of optical fibers;
at least one alignment structure configured to align the optical fibers with the waveguides on the silicon chip; and
a lens assembly comprising:
a first reflective surface; and
a second reflective surface,
wherein the first and second reflective surfaces are configured to reshape a profile of an optical beam transmitted between the waveguides and the optical fibers for efficient coupling.

16. The system of claim 15, wherein:
the first reflective surface is configured to receive an expanding optical beam from the plurality of waveguides, parallelize the optical beam, and reflect it to the second reflective surface; and
the second reflective surface is configured to receive the paralleled optical beam, focus it, and reflect it to the plurality of optical fibers.

17. The system of claim 15, wherein:
the second reflective surface is configured to receive an expanding optical beam from the plurality of optical fibers, parallelize the optical beam, and reflect it to the first reflective surface; and
the first reflective surface is configured to receive the paralleled optical beam, focus it, and reflect it to the waveguides.

18. The system of claim 16, wherein the profile of the optical beam received by the first reflective surface is an oval and is changed to a circular profile after reflection.

19. The system of claim 16, wherein the profile of the optical beam received by the second reflective surface is a circle and is changed to an oval profile after reflection.

20. The system of claim 15, wherein the alignment structure is a fiber array unit (FAU).
